(19) United States
(12) Patent Application Publication
(10) Pub. No.: US 2024/0032503 A1
(43) Pub. Date: Feb. 1, 2024

(54) CABLE-MOUNTED DISTRIBUTION ROBOT

(71) Applicants: Andrew Bennett, Belmont, MA (US); Arianna Ilvonen, Boston, MA (US)

(72) Inventors: Andrew Bennett, Belmont, MA (US); Arianna Ilvonen, Boston, MA (US)

(21) Appl. No.: 18/220,780

(22) Filed: Jul. 11, 2023

Related U.S. Application Data
(60) Provisional application No. 63/340,810, filed on May 11, 2022.

(51) Int. Cl. A01K 5/02; A01K 61/85; A01K 29/00

(52) U.S. Cl. CPC A01K 5/0266; A01K 5/0275; A01K 61/85; A01K 29/005

(57) ABSTRACT

The present invention relates generally to a system and a method for distributing materials in confined spaces, such as, for example, feeding animals in captivity. The system can be used to for example, animals through the operation of a cable mounted transport mechanism that carries storage container for food, a dispenser, and sensors that assist in the movement of the transport mechanism and the dispensing of food by the dispenser. Disclosed also is a method including the steps of (A) receiving, in a cable mounted transport mechanism, information regarding the timing for dispensing, (B) accessing information about the position(s) from which food should be dispensed, (C) sensing and monitoring the amount of food in the food storage container attached to the transport mechanism, (D) moving the cable mounted transport mechanism to the position(s) prescribed by the information accessed, and (E) dispensing food from the food storage container at the desired position(s) based upon the information regarding the timing for dispensing, the position(s) for dispensing and amount of food then in the food storage container.

### FIELD OF THE INVENTION

The invention relates generally to a system and a method for distributing materials in confined spaces, such as, for example, feeding animals in captivity.

### COPYRIGHT NOTICE

A portion of the disclosure of this patent application contains material that is subject to copyright protection. Noting the confidential protection afforded provisional patent applications, and to non-provisional application prior to publication, the copyright owner hereby authorizes the U.S. Patent and Trademark Office to reproduce this document and portions thereof prior to publication as necessary for its records. The copyright owner otherwise reserves all copyright rights whatsoever.

### BACKGROUND OF THE INVENTION

Farmers of many kinds provide food for the world's populations that is produced from farm-grown animals and plants. Separately, there are facilities around the world that keep and feed animals that are maintained in captivity (e.g., zoos), often in crowded conditions. Under the foregoing examples of captive animals (e.g., fish in ponds, pigs in pens, wildlife in large, encaged areas etc.) and of areas of plants (e.g., fields of mushrooms, fruits, and vegetables, etc.) and other similar situations, time, money, efforts, and other expenditures are necessarily spent to, among other things, feed the captive animals and the plants and to keep them healthy. Historically, much of the effort in such feedings require the manual transport of the food, medicine or fertilizer to specific feeding places at times dictated by the surroundings and the circumstances. The farmers typically try as best they can to minimize waste and to reduce the possibilities of under or overfeeding/applying, with the knowledge that there is always room for improvement. With the cost of feeding, medicine and fertilizer often be a relatively substantial expense in the care and maintenance of captive animals, there are obvious benefits with the minimization of the cost of the feeding activities.

For example, in aquaculture, one of the significant expenses is keeping fish fed and the cost of the feed itself. In terrestrial aquaculture ponds, this activity can be labor intensive as the farmer must go from pond to pond and scatter food. Likewise, antibiotics or other agents are sometimes applied in a similar fashion. Recent innovations include an “automatic dispenser,” which consists of a container of fish pellets and a rotating set of blades to “fling” the food into the pond. The dispenser can be started and stopped automatically (although such operation still requires going from pond-to-pond), or via a cell phone app. In either case, someone must still go from pond-to-pond to refill the pellet containers.

Continuing with the ‘fish in a pond’ example, in addition to the labor required, there is a problem with feed waste; both because uneaten pellets are an economic loss due to the cost of feed (purchased and never used), and because they settle into the pond and promote bacterial growth. This results in increased infections among the fish (which can result in the total loss of a pond's stock) and a chance of algal bloom, which robs the pond of oxygen, thereby killing the fish.

One of ordinary skill in the art would recognize that the feeding challenges faced by aquaculture farmers are not limited to feeding fish in ponds. Similar challenges have restricting impacts on feeding of animals in various other settings as well as distributing some medicines and fertilizers.

### SUMMARY OF THE INVENTION

The present invention intends to a system through which animals can be fed through a cable mounted transport mechanism that carries storage container for food, a dispenser, and sensors that assist in the movement of the transport mechanism and the dispensing of food by the dispenser. In a further embodiment, the transport mechanism is configured to ride along one or more cables suspended over one or more dispensing positions and moves over each dispensing position so that food can be dispensed a 360-degree dispensing spread area. When the dispensing is completed in a specific dispensing position, the transport mechanism can move to the next dispensing position and repeats the dispensing process. Finally, when the storage container is out of food or the dispensing session is completed, the transport mechanism returns to a launch point for system storage (when not deployed) and/or refilling, the latter of which removes the need to bring food distinctly to each dispensing position.

The inventive method includes the steps of (A) receiving, in a cable mounted transport mechanism, information regarding the timing for dispensing, (B) accessing information about the position(s) from which food should be dispensed, (C) sensing and monitoring the amount of food in the food storage container attached to the transport mechanism, (D) moving the cable mounted transport mechanism to the position(s) prescribed by the information accessed, and (E) dispensing food from the food storage container at the desired position(s) based upon the information regarding the timing for dispensing, the position(s) for dispensing and amount of food then in the food storage container. In a further embodiment of the inventive method, the dispensing of the food in the dispensing position is a 360-degree dispensing spread area under the transport mechanism. The movement of the cable mounted transport mechanism, controlled in part by information provided by sensors, is preferably along one or more cables suspended over one or more dispensing positions and the transport mechanism moves over each dispensing position so that food can be dispensed. When the dispensing is completed in a specific dispensing position (as predetermined or established by sensors), a further step would be the movement of the transport mechanism to the next dispensing position and then the repeat the dispensing process. A last step would preferably be the returning of the transport mechanism to a launch point for system storage (when not deployed) and/or for refilling, the latter of which removes the need to bring food distinctly to each dispensing position.

### BRIEF DESCRIPTION OF THE DRAWINGS

FIG. 1 shows a cross-sectional view on an embodiment of cable mounted transport mechanism, with a food storage container and a set of sensors.

FIG. 2 shows an exploded view of an embodiment of food storage container.

FIG. 3 shows a block diagram depicting various sensors that can be used in a preferred embodiment of the present invention

FIG. 4 shows an example of network of cables positioned over a series of ponds.

FIG. 5 is a flowchart showing the steps of an embodiment of the inventive method.

FIG. 6 is a flowchart that shows an embodiment of the inventive method that is more specifically configured for feeding fish in a series of ponds.

### DETAILED DESCRIPTION OF THE EMBODIMENTS

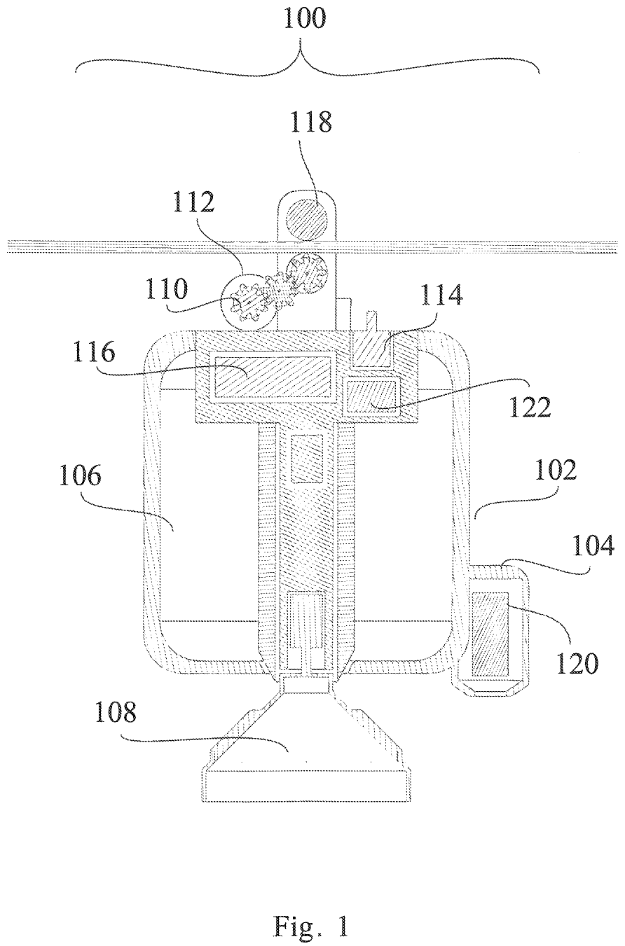

FIG. 1 shows the elements of an embodiment of cable mounted transport mechanism 100. The main components of this embodiment of transport mechanism 100 include, for example, main housing 102, sensor housing 104, food storage container 106, dispenser assembly 108, gear assembly 110, locomotion motor 112, transmitter/receiver 114, power source 116, cable grip rollers 118, camera system 120, and processing 122.

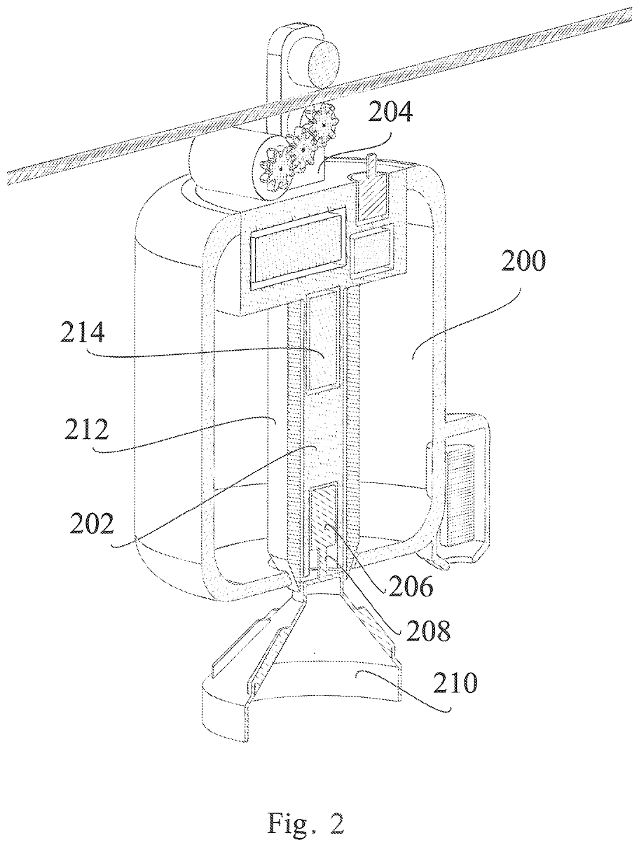

FIG. 2 shows the elements of an embodiment of food storage container 200, along with dispenser 202. These particular embodiments of food storage container 200 and dispenser 202 are similar to but shown in more detail than food storage container 106 and dispenser assembly 108, respectively, of FIG. 1. The main components of the embodiments of food storage container 200 and dispenser 202 include, for example, bracket 204 (which connects food storage container 200 to the applicable structure of the driving portion of the transport mechanism), spreader motor assembly 206, shaft 208 (the lower portion of which is connected to dispenser 202), spreader wheel 210, feed supply regulator paddle 212, feed supply regulator motor 214, feed supply cutoff 216, and feed supply cutoff motor 218.

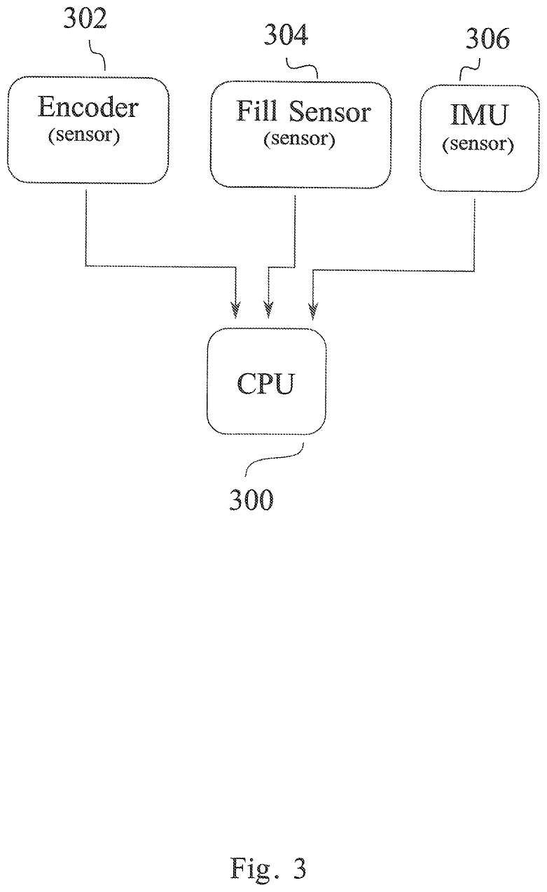

FIG. 3 shows a schematic of various sensors that can be used in a preferred embodiment of the present invention. The sensors are chosen to, for example, monitor (a) the health of the system, (b) the reaction and status of the spreading activity, and (c) the status of material spread. The sensors of FIG. 3 would be situated, in one embodiment of the present invention, in and in proximity to the equivalent to sensor housing in FIG. 1. In the schematic, each of the sensors are connected to the equivalent of power source 116 in FIG. 1. Additionally, each of the sensors is directly connected electronically to CPU 300. Sensor 302 assists in the movement of the transport mechanism, thus the readings from sensor 302 are transmitted to CPU 300. Sensor 304 monitors the dispensing of food by the dispenser by reading the amount of food in the equivalent of food storage container 106, thus the readings from sensor 304 are transmitted to CPU 300. Sensor 306 monitors environmental considerations to be considered in the movement of the transport mechanism and/or the dispensing of the food. Accordingly, the readings from sensor 302, sensor 304 and sensor 306 are considered together in the activation and controlling of, among other components, the equivalents of dispenser 108 and motor 112 to control the positioning of system 298 and the distribution of food.

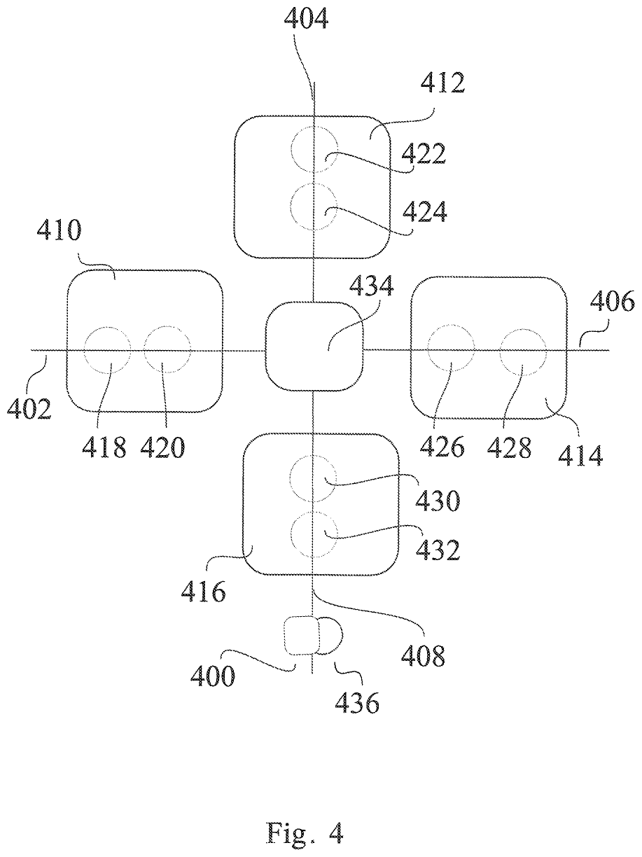

FIG. 4 shows an example of network of cables positioned over a series of ponds containing fish. One embodiment of the inventive system transport mechanism 400 is configured to ride along cables with segments 402-408 suspended over and along the sides of ponds 410-416. In another embodiment of the inventive system, transport mechanism 400 is anchored and attached to a movable length of cable upon which the dispensing mechanism 436 is attached, allowing the dispensing mechanism and associated sensors to move along the series of ponds. The 360-degree dispensing spread areas are shown as 418-432. Structure 434 is the housing and food filling station. When the dispensing is completed in a specific dispensing position (like dispensing spread area 418), transport mechanism 400 can move the dispensing mechanism 436 to the next dispensing position (like dispensing spread are 420) and repeats the dispensing process. When the storage container attached to transport mechanism 400 is out of food or the dispensing session is completed, transport mechanism 400 returns to structure 434 for system storage (when not deployed) and/or refilling, the latter of which removes the need to bring food distinctly to each dispensing position. When the present invention is used to feed, for example, pigs or chickens, it may be preferrable for the results of the dispensing to be spread food in a line, as opposed to spread over an area.

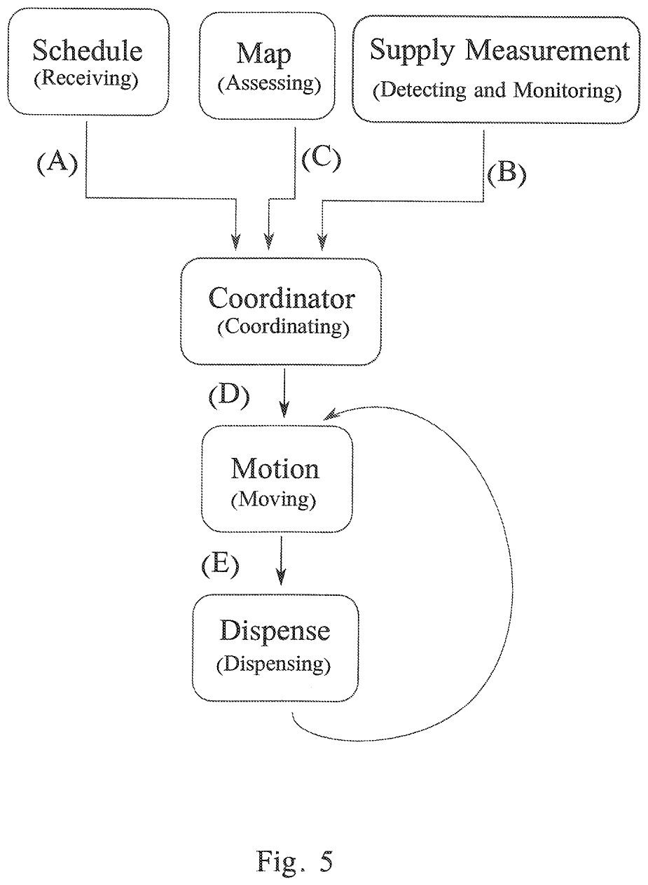

As shown in the flow chart in FIG. 5, a preferred embodiment of the inventive method includes the steps of (A) receiving, in a cable mounted transport mechanism, information regarding the timing for dispensing, (B) detecting and monitoring the amount of food in the food storage container attached to the transport mechanism, (C) accessing information about the position(s) from which food should be dispensed, (D) moving the cable mounted transport mechanism to the position(s) prescribed by the information accessed, and (E) dispensing food from the food storage container at the desired position(s) based upon the information regarding the timing for dispensing, the position(s) for dispensing and amount of food then in the food storage container,

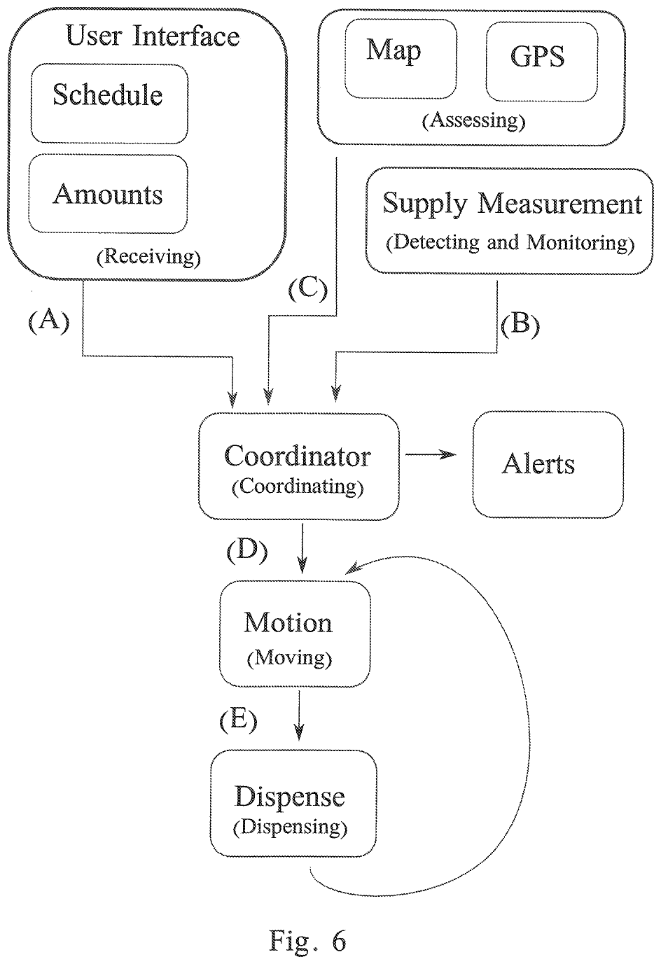

The flow chart shown in FIG. 6 shows the general steps of the method expressed in FIG. 5 with additional steps and with a focus on the feeding of fish. The operator enters preferred dispensing times as part of receiving step (A). The current time is tracked against desired dispensing times and/or conditions (e.g., a specific time or dusk/dawn). When dispensing time has arrived, and if weather conditions are favorable, then the system executes a dispensing cycle. Otherwise, it can inform the operators that current conditions are not favorable for dispensing of food, medication, or other material.

In step (B), the system determines the amount of food, medicine or other material available in the storage mechanism to check against the amount required to perform the dispensing activity, as well as environmental conditions which could have an adverse effect on the material to be distributed. The required amount can be pre-determined by the operator or could be based upon historic dispensing data from prior dispensing. If there are insufficient material, the system can either alert personnel and request additional materials/supplies, or it may be able to automatically fill the storage mechanism itself (e.g., as part of a docking station). If the conditions are unsuitable for dispensing based upon the expected payload requirements, the system can inform the operators accordingly.

In step (C), the system is supplied information about the location to position the dispensing location, based upon the distance along the cable, a GPS position, a position relative to the geometry of, for example, the feeding pond/pen and surrounding area, or some combination of these.

In step (D), the system moves to the desired location to initiate dispensing.

In step (E), the system begins distributing the applicable material (e.g., feed or medicine) according to the information supplied by the operator about the activity. The material might be spread out radially or in a line and will be spread until such time as target conditions for stopping the operation are met. These conditions can be based upon, for example, the amount distributed, the area covered, the reaction of the animals being fed or some other metric determined by the operators.

The distribution of material can vary based upon the material being distributed and, for example, the animals and/or areas being serviced. In the case of highly competitive animals, such as fish, the food can be distributed radially all around the dispenser. Other animals which are less competitive, such as pigs, sheep, cattle, chickens, etc. can have food distributed in piles or lines.

The dispenser can be moved about the area using multiple methods of cable mechanisms. For example, the preferred dispenser and cable transport mechanism can be a combined unit that is attached to a cable of convenience and moves along the cable. In another embodiment of the system, the transport mechanism is anchored in one location and the cable is passed through the transport mechanism with the dispenser affixed to the cable. The transport mechanism thereby moves the dispenser by moving pulling the cable in one direction of another, much like a cable car is moved in one direction or another by a mechanism located in the base station. In yet another embodiment of the system, the dispenser can be attached to multiple cables at the same time, with transport mechanisms attached to each cable. The dispenser is then moved via coordinated activity of the transport mechanisms, much like the control of a camera suspended over a sports stadium.

Between missions and/or when weather or a system error requires, the mechanism returns the dispenser to a launch point or shelter point for servicing, storage, or reloading.

Because the transport mechanism can be centered over, for example, a pond to spread food, it can reach a larger number of eaters at one time. This breadth has a significant benefit over the conventional “fling” style dispenser, which sits on the shore or otherwise in a ‘on the side’ fixed location spreading food in a narrow path, in that the transport mechanism, with the attached components, removes the geometric bias of food distribution from one side or one end of the dispensing area. Accordingly, the eaters (e.g., fish) are not forced to crowd together to compete for food. By spreading the food out more evenly, the eaters can access it more efficiently. This efficiency reduces food going unnoticed by the eaters due to them begin crowded together.

In a preferred embodiment, the sensing system tracks the activity of the eaters during dispensing. This monitoring can be accomplished by vision (e.g., watching the fish eaters), audio (e.g., listening to the activity of the fish while feeding), radar (e.g., monitoring the disturbance in the water due to fish feeding activities) or any other sensing mechanism that monitors the dispensing activity. When, for example, activity slows down due to the eaters becoming sated, the dispenser automatically stops distributing food. This type of curtailing prevents the waste of food, which otherwise might have gone uneaten and results in a significant cost savings due to feed being a sizable portion of an operation's expenses.

### Additional Thoughts

The foregoing descriptions of the present invention have been provided for the purposes of illustration and description. It is not intended to be exhaustive or to limit the invention to the precise forms disclosed. Many modifications and variations will be apparent to the practitioner of ordinary skilled in the art. Particularly, it would be evident that while the examples described herein illustrate how the inventive apparatus may look and how the inventive method may be performed. Further, other elements and/or steps may be used for and provide benefits to the present invention. The depictions of the present invention as shown in the exhibits are provided for purposes of illustration.

The embodiments were chosen and described in order to best explain the principles of the invention and its practical application, thereby enabling others of ordinary skill in the art to understand the invention for various embodiments and with various modifications that are suited to the particular use contemplated.

What is claimed is:

1. A system for distributing materials to animals, comprising
a cable mounted transport mechanism;
a storage container for materials that can be connected to such cable mounted transport mechanism,
a dispenser mounted on such storage container, and
sensors mounted on such storage container that assist in the movement of the cable mounted transport mechanism and in the dispensing of materials by such dispenser.

2. The system of claim 1 wherein the cable mounted transport mechanism is configured to ride along at least one cable suspended over at least one dispensing position and to move over to and from such at least one dispensing position so that materials can be dispensed over a 360-degree spread area.

3. The system of claim 2 wherein when the dispensing is completed in a specific dispensing position, the cable mounted transport mechanism can move to the next dispensing position and repeat the dispensing process.

4. The system of claim 3 wherein when the dispensing is completed, the cable mounted transport mechanism returns to a launch point for system storage.

5. The system of claim 3 wherein when the dispensing is completed, the cable mounted transport mechanism returns to a launch point for refilling, which removes the need to bring materials distinctly to each dispensing position.

6. The system of claim 1 wherein the cable transport mechanism includes main housing, a sensor housing, a gear assembly, a locomotion motor, a transmitter/receiver, power source. cable grip rollers, camera system, and processing.

7. The system of claim 1 wherein the such dispenser connects to such materials storage container by a bracket, and such dispenser includes a spreader motor assembly, a shaft, a spreader wheel, a feed supply regulator paddle, a feed supply regulator motor, a feed supply cutoff, and a feed supply cutoff motor.

8. The system of claim 1 wherein the materials are food and the animals are fish.

9. The system of claim 1 further comprising an instrument to monitor the dispensing of the materials to prevent over-supply of the materials.

10. The system of claim 9 wherein the monitoring senses the behavior of the animals as the materials are being dispensed.

11. The system of claim 9 wherein the instrument can identify sick animals.

12. A method of distributing materials to animals comprising the steps of:
receiving, in a cable mounted transport mechanism, information regarding the timing for dispensing,
accessing information about at least one position from which materials should be dispensed,
sensing and monitoring the amount of materials in the materials storage container attached to the cable mounted transport mechanism,
moving the cable mounted transport mechanism to such at least one position prescribed by the information accessed, and
dispensing materials from the materials storage container at such at least one position based upon the information regarding the timing for dispensing, the location of such at least one position for dispensing, and the amount of materials then in the materials storage container.

13. The method of claim 12 wherein the dispensing of the materials in the dispensing position is a 360-degree spread area under the cable mounted transport mechanism and wherein the movement of the cable mounted transport mechanism, controlled in part by information provided by sensors, is along at least one cable suspended over at least one dispensing position and the cable mounted transport mechanism moves over to and from such at least one dispensing position so that materials can be dispensed.

14. The method of claim 13 wherein when the dispensing is completed in a specific dispensing position, with the method further comprising a step of moving the cable mounted transport mechanism to the next dispensing position and then repeating the dispensing process and further comprising the steps of returning the cable mounted transport mechanism to a launch point for system storage and refilling, thus removing the need to bring materials distinctly to such at least one dispensing position.

15. The method of claim of 12 wherein preferred dispensing times are used as part of receiving step, the current time is tracked against desired dispensing times and conditions and, when dispensing time has arrived, and if weather conditions are favorable, dispensing cycle is commenced.

16. The method of claim of 12 wherein the amount of materials to be dispensed is determined by a check of the amount required to for the dispensing cycle, as well as an evaluation of environmental conditions which could have an adverse effect on the material to be dispensed.

17. The method of claim of 12 wherein information supplied about the dispensing location establishes the desired position for a material dispenser within the travel area of a cable mounted transport mechanism using GPS positioning, with the desired position being relative to the geometry of the dispensing and surrounding area.

18. The method of claim of 12 wherein the dispenser is movable to at least one desired location for dispensing.

19. The method of claim of 12 wherein dispensing of the applicable material begins according to the information supplied by an operator, with the material capable of being spread until such time as target conditions for stopping the operation are met.

20. The method of claim 12 wherein the materials are food and the animals are fish.
